(19) United States
(12) Patent Application Publication
(10) Pub. No.: US 2008/0280061 A1
(43) Pub. Date: Nov. 13, 2008

(54) Method for sealing natural stone

(76) Inventors: Roger Questel, Arlington, VT (US); David Pelletier, Leicester, VT (US); Larry Wasowski, Charlotte, NC (US); Gary Marmer, Dorset, VT (US)

Correspondence Address: Kevin M. Farrell;Pierce Atwood, Suite 350, One New Hampshire Avenue, Portsmouth, NH, 03801, US

(21) Appl. No.: 12/151,515

(22) Filed: May 7, 2008

Related U.S. Application Data
(60) Provisional application No. 60/928,029, filed on May 7, 2007.

(51) Int. Cl. B05D 3/06

(52) U.S. Cl. 427/508

(57) ABSTRACT

Provided is a novel method for sealing natural stone. The method comprises applying a base coat comprising a synthetic polymer, drying the base coat, applying a UV-cure topcoat, volatizing organic solvents from the topcoat, and curing the UV-cure topcoat by exposure to UV light. The UV-cure topcoat used in the method comprises an acrylate oligomer, photoinitiators, and flow and wetting additives. Methods are also provided wherein the topcoat further comprises a fungal inhibitor. The described methods provide a coating with excellent adhesion, and a smoother, more uniform topcoat. Moreover, this coating system allows moisture to migrate from the back side of tile through the coatings to evaporate to the surface, a feature critical to preventing deterioration of the stone over time.

### BACKGROUND

The Q-Seal™ process, described herein, is a method for protecting the surface of natural stone through a unique sealing process. Natural stone; including marble, granite, travertine, limestone, slate, and sandstone; is naturally porous and therefore must be sealed to provide a water resistant surface and to protect the surface from staining. Currently the methods available to consumers involve an after market product that is typically applied after installation of the stone surface and must be periodically re-applied.

### SUMMARY

The process of the present invention applies a protective coating to natural stone prior to installation. First an initial base coat or tie-coat is applied to prepare and seal the surface of the stone. The base coat is followed by a UV topcoat. The application of a base coat solves the adhesion and porosity problems that normally occur between the natural stone surface and the UV topcoat. The base coat serves as a bonding surface between the tile surface and the topcoat, ensuring adhesion. Further, this coatings system allows moisture to migrate from the back side of the tile through the coatings to evaporate to the surface. Allowing the migration of moisture through the body of the stone tile as well as through the coatings system is a critical feature to the successful installation of the tile. Without this particular feature stone tile will deteriorate after installation over a period of time. Coatings which do not allow transmission of moisture may result in tile degradation. The base coat also acts as a filler, filling in and smoothing out the surface porosity inherent in natural stone and allowing for a smoother more uniform topcoat. The base coat is comprised of a waterborne polymer dispersion formulated with sufficient organic coalescing solvents and additives to provide a continuous film at or slightly above room temperature. The base coat is spray applied at 1.5 to 2.0 mil wet film thickness (WFT). Surface heating via IR lamps is required to ensure coalescence and evaporation of water/solvents. The UV-curable topcoat is then applied at 1.5 to 2.0 mil WFT, followed by a solvent flashing step, then UV curing. A mold and mildew inhibitor can be added to the topcoat formula providing unique properties to the sealed products.

Properties of this coating/sealing system when applied to natural stone include excellent adhesion (taped crosshatch test), uniform appearance and gloss, stain and mildew resistance, and hot water emersion resistance.

### DETAILED DESCRIPTION

The present invention involves a novel method for sealing natural stone. The method renders the stone's surface water resistant and protects it from staining. The method is an improvement over currently available methods because the method is performed before installation of the stone and does not have to be periodically repeated. Existing stone sealing technology requires periodic re-application of sealing products. In addition, the coatings system of the present invention allows moisture to migrate from the back side of the tile through the coatings to evaporate to the surface, a critical feature to the successful installation of the tile. Without this particular feature stone tile will deteriorate after installation over a period of time.

In general, natural stone has a porous surface and is subject to staining, entry by water and other liquids, and fungal growth. An object of the present invention is to provide a superior method for sealing natural stone. The method comprises applying a base coat solution to natural stone, wherein the base coat comprises an aqueous dispersion of a synthetic polymer, the weight of the synthetic polymer ranging from 20%-40% of the base coat solution. The base coat is applied to a wet film thickness (WFT) ranging from 0.5 to 2.5 mil. The base coat is then dried. The drying step can be performed by surface heating via infra-red (IR) lamps. The heating ensures the coalescence and evaporation of water/solvents. Application of the base coat and drying steps are followed by the application of a UV-cure topcoat. The UV-cure topcoat comprises a 20%-40% by weight dispersion of acrylate oligomer in a volatile organic solvent or mixtures thereof. The topcoat further comprises photoinitiators, and flow and wetting additives. The topcoat is also applied to a WFT of 0.5 to 2.5 mil. The volatile organic solvent or mixtures thereof are then volatilized from the coating and the resultant product is exposed to UV light thereby curing the UV-cure topcoat by promoting cross-linking of the acrylate oligomer. The volatizing or solvent flashing step may be performed by IR assist where the stone tile is passed under IR lamps. The lamps heat the coating thus accelerating the removal of volatiles.

The method of the present invention includes an embodiment of the above method wherein the base coat comprises an aqueous dispersion of synthetic polymer having a percentage of dispersed synthetic polymer ranging from 25% to 35% by weight. A preferred weight of the synthetic polymer dispersed in the waterborne base coat is 28.6%.

The base coat is comprised of a waterborne polymer dispersion formulated with sufficient organic coalescing solvents and additives to provide a continuous film at or slightly above room temperature. The methods of the present invention include those where the synthetic polymer type is urethane, polyester, acrylic, or a hybrid thereof. Polymer hybrids of urethane, polyester, and acrylic aqueous dispersions include both physical mixtures as well as more intimately combined polymers conducted during the synthetics stages. Prior to, or subsequent to the synthetics stages, the polymer hybrid may be in aqueous dispersion form.

The methods of the present invention also include the embodiment wherein the dispersion medium of the base coat further comprises 10% to 15% by weight of 2-butoxy ethanol [111-76-2] and/or trace amounts of dinonyl phthalate plasticizer. These filming aids are useful in inducing the base coat polymer to form a continuous film. Additional filming aids may include materials such as glycol ethers, glycol ether esters, and N-methyl pyrrolidone. Calculating by subtraction, the base coat contains about 60% water by weight.

The methods of the present invention further include the embodiment wherein the UV-cure topcoat comprises a 27% to 37% by weight dispersion of the acrylate oligomer in a volatile organic solvent or mixtures thereof. Ideally, the UV-cure topcoat is approximately 32% solids by weight. The invention includes embodiments wherein the volatile organic solvent of the topcoat may include methyl propyl ketone, methyl isobutyl ketone, and ethyl alcohol, with trace levels of ethyl acetate. The invention includes the above methods wherein the topcoat further comprises amorphous silica. The amorphous silica diffuses light and aids in gloss control.

The photoinitiator package used in the invention is typically known in the art. The invention includes methods wherein the photoinitiators of the topcoat are selected from methanone, - (1-hydroxycyclohexyl) phenyl, [947-19-3]; and phosphine oxide, phenylbis (2,4,6-trimethyl benzoyl).

As described above, the base coat and UV-cure topcoat are each applied to a WFT ranging from 0.5 to 2.5 mil. The invention includes embodiments wherein the base coat is applied to a WFT of 1.5 to 2.0 mil and/or wherein the topcoat is applied to a WFT of 1.5 to 2.0 mil. Both the base coat and the topcoat can be spray applied.

In another embodiment the invention includes methods wherein the UV-cure topcoat of the above methods further comprises a mold and mildew inhibitor or biocide, thus providing unique properties to the sealed stone products. One having skill in the art would be aware that there are many biocides which may be added to the topcoat to inhibit the growth of bacteria and fungi. The methods of this invention have been practiced using the product, Ultra-Fresh® (Thomson Research Associates), a bacteriostatic and fungistatic liquid preservative with active ingredient 2-n-Octyl-4-isothiazolin-3-one in a propylene glycol solvent carrier. Ultra-Fresh® is effective in inhibiting the growth by microorganisms such as Aspergillus niger, Chaetomium globosum, Penicillium funiculosum, Aureobasidium pullulans, and Trichoderma virens.

The purpose of the base coat of this invention is to prepare and seal the surface of the natural stone. Applying a base coat solves the adhesion and porosity problems that normally occur between the natural stone surface and the UV-cure topcoat. The base coat serves as a bonding surface between the tile surface and the topcoat, ensuring adhesion. Furthermore, coatings which do not allow transmission of moisture can result in tile degradation. This coating system provides a product which allows moisture to migrate from the backside of the stone tile through the coatings to evaporate to the surface, thus protecting the stone tile from deterioration. The base coat also acts as a filler, filling in and smoothing out the surface porosity inherent in natural stone and allowing for a smoother more uniform topcoat.

### Laboratory Example of Sealing Technology

Onto a 12 inch by 12 inch tumbled marble tile, a coating of waterborne tie-coat was spray applied at about 1.75 mil WFT. Following the spray coating, the tile was exposed for 60 seconds in an infrared oven to warm the coated tile to about 30 to 40° C. Next, the same tile was coated by spraying a UV-curable topcoat at about 1.75 mil WFT, then dried for about 60 seconds in an IR oven, followed by exposure to high intensity UV radiation for about 3 to 5 seconds. The resulting coating is dry to the touch having excellent adhesion. Taped crosshatch test results give a rating of 5B, per the ASTM D-3359, Method B.

What is claimed is:

1) A method for sealing natural stone, the method comprising:
a) providing a base coat comprising an aqueous dispersion of a synthetic polymer having a percentage of dispersed synthetic polymer ranging from 20% to 40% by weight;
b) applying the base coat to natural stone to a wet film thickness ranging from 0.5 to 2.5 mil;
c) drying the base coat;
d) providing a UV-cure topcoat comprising a 20%-40% by weight dispersion of acrylate oligomer in a volatile organic solvent or mixtures thereof, the UV-cure topcoat further comprising photoinitiators, and flow and wetting additives;
e) applying the UV-cure topcoat to natural stone over the dried base coat of step c) to a wet film thickness of 0.5 to 2.5 mil;
f) volatizing the volatile organic solvent or mixtures thereof; and
g) exposing the product of step f) to UV light thereby curing the UV-cure topcoat by promoting the cross-linking of the acrylate oligomer.

2) The method of claim 1 wherein the base coat comprises an aqueous dispersion of synthetic polymer having a percentage of dispersed synthetic polymer ranging from 25% to 35% by weight.

3) The method of claim 1 wherein the synthetic polymer is selected from the group consisting of urethane, polyester, acrylic and hybrids thereof.

4) The method of claim 1 wherein the UV-cure topcoat further comprises amorphous silica.

5) The method of claim 1 wherein the UV-cure topcoat further comprises a mold and mildew inhibitor.

6) The method of claim 1 wherein the volatile organic solvent is selected from the group consisting of methyl propyl ketone, methyl isobutyl ketone, and ethyl alcohol.

7) The method of claim 1 wherein the photoinitiators are selected from the group consisting of methanone, - (1-hydroxycyclohexyl) phenyl, [947-19-3]; and phosphine oxide, phenylbis (2,4,6-trimethyl benzoyl).

8) The method of claim 1 wherein the UV-cure topcoat comprises a 27%-37% by weight dispersion of acrylate oligomer in a volatile organic solvent or mixtures thereof.

9) The method of claim 1 wherein the base coat further comprises 10% to 15% by weight 2-butoxy ethanol [111-76-2].

10) The method of claim 1 wherein the base coat further comprises dinonyl phthalate plasticizer.

11) The method of claim 1 wherein the base coat is applied to a wet film thickness of 1.5 to 2.0 mil.

12) The method of claim 1 wherein the UV-cure topcoat is applied to a wet film thickness of 1.5 to 2.0 mil.

13) The method of claim 1 wherein natural stone is selected from the group consisting of marble, granite, travertine, limestone, slate, and sandstone.
